(19) United States
(12) Patent Application Publication
(10) Pub. No.: US 2014/0358984 A1
(43) Pub. Date: Dec. 4, 2014

(54) System and Process for Supervising Communication Between Application Components

(71) Applicant: UNIVERSITE DE PAU ET DES PAYS DE L'ADOUR, Pau Cedex (FR)

(72) Inventors: Marc DALMAU, La Bastide Clairence (FR); Philippe ROOSE, Ustaritz (FR)

(21) Appl. No.: 14/289,392

(22) Filed: May 28, 2014

(30) Foreign Application Priority Data
May 29, 2013 (FR) 1354891

(51) Int. Cl. H04L 29/08; H04L 12/26

(52) U.S. Cl. CPC H04L 67/10; H04L 43/12
USPC 709/201

(57) ABSTRACT

A system is provided for supervising applications executing on a set of electronic devices connected together by one or more networks, characterized in that each device comprises a local supervision entity, the supervision entities cooperating together to control the applications executing on the electronic devices, each application comprising a set of application components, each application component being encapsulated in a container and the components being connected together by connectors, each component container comprising at least one input unit for receiving the input streams, at least one output unit for receiving the output streams, and a control unit, the supervision entity of the device hosting a component being able to control the life cycle of the component between the devices by using the control unit, while the component is able to access its input and output data by using the input and output units of the container.

### CROSS-REFERENCE TO RELATED APPLICATION

This application claims priority to foreign French patent application No. FR 1354891, filed on May 29, 2013, the disclosure of which is incorporated by reference in its entirety.

### FIELD OF THE INVENTION

The present invention generally relates to electronic devices and in particular to a supervising process and system for controlling the application components executing on such devices.

### BACKGROUND

Recent technological advances over the last few years have placed the emphasis on the democratization of wireless networks and on the miniaturization of communication kit. Currently, there exists on the market a multitude of personal electronic devices that are ever more lightweight, compact, mobile and endowed with diverse means of wireless communication, such as portable telephones, intelligent mobile telephones (“smartphones”), tablets, laptop computers or else sensors. These devices concentrate complex and very diversified functionalities: telephony, instant messaging, Internet browsing, location system (GPS standing for “Global Positioning System”), audio player, etc.

These devices form the subject of a growing demand for ever richer and more customized services. The challenge is to be able to propose applications for these devices which adapt both to the wishes of the users and to the physical environment in which they operate.

Mobile electronic devices have the capability to be able to account not only for their hardware and software environment but also, with the arrival of peripherals such as wireless sensors or sensors integrated into portable telephones, to be able to measure physical quantities related to the environment of the device or to the device itself, such as temperature, pressure or else speed of movement. The integration of the data arising from such devices into the applications may make it possible to offer users services that are better adapted to their current situation. However, these devices possess characteristics (energy autonomy, mobility, limited resources) which necessitate the adaptation of the applications as well as of the services rendered by the latter to ensure correct operation for a sufficient duration, and service continuity in case of unavailability of a peripheral of the electronic device, for example when a peripheral of the electronic device no longer possesses sufficient battery. In the absence of service continuity, all the services offered by the peripheral then cease to operate, implying a break in service. This may result in limited comfort of use for the user, notably in the case where applications are currently executing.

Context-sensitive supervision systems are known which react to changes of context to provide the user with services adapted to the situation. Such systems can rely on various types of adaptations: adaptation of content, adaptation of presentation, adaptation of behaviour, structural adaptation, adaptation of deployment.

Thus, supervision systems exist for adapting the content of the applications which execute on electronic devices as a function of context, such as for example the solution described in Christoph Dorn, Richard N. Taylor—Co-adapting human collaborations and software architectures—ICSE 2012 Proceedings of the 2012 International Conference on Software Engineering—pp. 1277-1280. As a function of the situation, the data can be modified so that the user is presented only with those which are relevant to his situation.

Other known systems are configured to adapt the presentation in the field of MMIs (the acronym standing for Man Machine Interface). As a function of the hierarchical status of the user, the interface of the application will or will not present an information item and will or will not propose a functionality, such as for example the solution described in the article by Y. Gabillon, G. Calvary, H. Fiorino, entitled “Composition d'Interfaces Homme-Machine en contexte: approche par planification automatique” [Composition of Man Machine Interfaces in context: approach by automatic planning”, Revue TSI. Vol. 30, 2011.

In yet other systems, there is envisaged an adaptation of behaviour which relies on the adaptation of the functionalities provided by a component or a service as a function of the context, such as for example the solution described in the article by Peyman Oreizy, Nenad Medvidovic, Richard N. Taylor, entitled “Runtime Software Adaptation: Framework, Approaches, and Styles”, ICSE Companion '08 Companion of the 30th international conference on Software engineering, pp. 899-910. In yet other approaches, the supervision systems carry out a structural adaptation which is aimed at modifying the composition of the application and/or the connections between the various components with the aim of obtaining an application whose behaviour remains unchanged. This type of adaptation is more customarily used in the field of components based distributed applications.

Supervision systems are also known which adapt the deployment as a function of the context, as proposed for example in the article by Ning Gui, Vincenzo de Florio, Hong Sun, Chris Blondia entitled “Toward architecture-based context-aware deployment and adaptation”, The Journal of Systems and Software 84 (2011) 185-197—Elsevier, 2011. Such systems implement deployments which take into account the properties of the peripherals supporting the application. This type of adaptation is often used to cope with the problems engendered by the hardware limitations of the mobile and constrained devices, used massively nowadays.

Existing solutions relying on adaptation of content, adaptation of presentation and adaptation of functionality are essentially directed towards the user. The content and the functionalities are adapted as a function of his preferences and the presentation is adapted as a function of his status for example. Adaptations of structure and of deployment are particularly appropriate for hardware constraints and for network constraints. However, the functionalities remain unchanged despite changes of context.

Solutions relying on structural adaptation and adaptation of deployment make it possible to adapt the functionalities as a function of context. An application is then represented by an assemblage of components that it is possible to modify by elementary operations such as addition, deletion of components as well as of connections between these components. These elementary operations act on the structure of the application.

Among the solutions based on structural adaptation as a function of context, the article by O. Riva, T. Nadeem, C. Borcea, L. Iftode, Context-Aware Migratory Services, in Ad Hoc Networks IEEE Transactions on Mobile Computing, Vol. 6, No. 12, December 2007, proposes a service model allowing adhoc networks to provide services capable of adapting to context so as to offer the client service continuity. A migration service supervises the services and reacts by triggering migrations of services whenever a node is no longer capable of supporting the execution of the service, causing the continuation of the service on another node. The migration aspect is rendered invisible to the client applications through the use of a single virtual terminal. Also known is an approach based on lightweight components for designing composite Web services, which is described in the article by V. Maurin, N. Dalmasso, B. Copigneaux, S. Lavirotte, G. Rey, J. Y. Tigli, Simply engine-wcomp: plate-forme de prototypage rapide pour l'informatique ambiante basée sur une approche orientée services pour dispositifs réels/virtuels [fast prototyping platform for ambient computing based on a services oriented approach for real/virtual devices], David Menga and Florence Sedes, editors, UbiMob, volume 394 of ACM International Conference Proceeding Series, pages 83-86. ACM, 2009. This solution makes it possible to construct applications in the form of Web services graphs based on the container concept. Moreover, it provides middleware based on the concept of Assemblage Aspects making it possible to adapt Web services. Such a solution allows the reuse of services and thereby extensibility and communication based on events, thus guaranteeing high system reactivity. Another advantage of this solution is that it allows the mobility of the applications (Web service paradigm) and affords flexibility at the level of the structure that it is possible to adapt (component paradigm).

The MUSIC project (R. Rouvoy, P. Barone, Y. Ding, F. Eliassen, S. Hallsteinsen, J. Lorenzo, A. Mamelli, and U. Scholz. MUSIC: Middleware Support for Self-Adaptation in Ubiquitous and Service-Oriented Environments—Book on Software Engineering for Self-Adaptive Systems (SEfSAS). LNCS 5525-2009) provides middleware allowing the reconfiguration of mobile context-sensitive applications. The adaptation process defined in MUSIC relies on the principles of planning based adaptation. Planning based adaptation refers to the capability for reconfiguration of an application in response to changes of context by exploiting awareness of its composition and of the Quality of Service metadata associated with each of its constituent services.

In the article by D. Ayed, C. Taconet, G. Bernard, and Y. Berbers. Cadecomp, “Context-aware deployment of component-based applications”, J. Network and Computer Applications, 31(3) 2008, middleware is proposed for the context sensitive deployment of components based applications. This middleware extends the existing deployment services by integrating therewith the adaptation capabilities necessary in the field of mobile applications and constrained peripherals. It proposes a context-sensitive automatic deployment on the fly: an application is installed at the moment of its access and uninstalled just after the end of its use. The applications are considered to be a collection of components distributed over the network and connected together via ports. The deployment is defined according to five parameters: the architecture of the application, the placement of the instances of the components, the choice of their implementation, the properties of the components and their dependencies. This middleware relies on a data model making it possible to describe the context which acts on the deployment and to define deployment contracts which associate with each context situation all the possible variations of the deployment parameters. The context essentially models the characteristics of the instances of the components. This information is collected during specification and development by the producer of the component. It makes it possible to specify constraints on the placement of the components as well as on the connections, compulsory or optional.

The OSGi service platform (the acronym standing for “Open Services Gateway initiative”) implements a component model (called a “Bundle” (called a “Bundle”). They possess a life cycle allowing them to be stopped, booted, updated and uninstalled warm. The service called “registry” makes it possible to register component models (bundles) in the guise of services and to detect the appearance or the deletion of others. OSGi is based on the discovery of services. However, the OSGi platform does not support the migration of components between peripherals and is based on the discovery of services.

The existing solutions thus propose various approaches to the structural adaptation of applications: software sketch, middleware, execution platform. However, none of the proposed approaches allows entirely dynamic and transparent decentralized supervision of the application components on a set of mobile devices, that could be of different kinds and connected by all types of networks, as a function of context. Moreover, none of the existing solutions proposes such a supervision system capable of controlling the communication between the application components.

### SUMMARY OF THE INVENTION

For this purpose, the invention proposes a system for supervising applications executing on a set of electronic devices connected together by one or more networks. Each device comprises a local supervision entity, the supervision entities cooperating together to control the applications executing on the electronic devices. Each application comprises a set of application components, each application component being encapsulated in a container and the components being connected together by connectors. Each component container comprises at least one input unit for receiving the input streams, at least one output unit for receiving the output streams, and a control unit, the supervision entity of the device hosting a component being able to control the life cycle of the component between the devices by using the control unit, while the component is able to access its input and output data by using the input and output units of the container.

According to a characteristic of the invention, the component can access its input data, by direct reading on a chosen stream, by an operation of disabling until a data item is available.

As a variant, the component can access its input data, by direct reading of the first data item available on one of the input streams, by a disabling operation.

According to another characteristic of the invention, the component container comprises a set of listeners placed on at least some of these input streams, and each listener can call a method for reading data, in response to the presence of a data item on the input stream where the listener is placed.

The container can furthermore comprise a listeners manager cooperating with the control unit of the component container to activate listeners on input streams of the component, in response to an item of information, transmitted to the control unit by an input connector, regarding availability of data on the input connector.

In response to a command to stop the component, transmitted by the supervision entity of the device hosting the component to the control unit of the container of the component, the control unit can stop the listening manager.

According to another aspect of the invention, the component can write directly on an output stream, the operation being disabling if no output stream is connected to the corresponding output.

In response to a command to start the component, transmitted by the supervision entity of the device hosting the component to the control unit of the container of the component, if the component is not connected to a connector, the control unit can start the component and continue its execution as long as the component does not attempt to access an input stream or an output stream.

In response to a command to stop an input unit of the component, transmitted by the supervision entity of the device hosting the component to the control unit of the container of the component, the control unit can stop the component if the component attempts to read a data item on the stopped input unit.

In response to a command to stop a component or to migrate a component to another device, transmitted by the supervision entity of the device hosting the component to the control unit of the container of the component, the control unit can stop all the input units of the component.

Moreover, each input unit of the active component can, on each attempted reading of the component on the input unit, attempt to recover data if it is connected to a connector or to disable the readings of the component on the input unit until it is connected to a connector.

According to a characteristic of the invention, each connector is encapsulated in a container of connector, an input unit, an output unit and a control unit cooperating with the supervision entity.

The supervision entity of a given device can, in response to the receipt of a command to create a connector between the given device, so-called the source device, and a target device, the source device and the target device having compatible communication means:
send a command to create a container of connector on the target device and locally create a container of connector on the source device,
synchronize the creation of the connectors on the source device and the target device, according to a mechanism of acknowledgement message exchange between the devices.

In response to the receipt of a command to create a connector between the given device, termed the source device, and a target device, the source device and the target device having incompatible communication means, the supervision entity of a given device can:
calculate a route between the source device and the target device,
for each next relay device in the route between the source device and the target device having communication means compatible with the source device and the target device, until the target device is reached:
   sending a command to create a connector (303) container (805) on said next relay device,
   locally creating a container of connector (805A) on the current device which has sent the command, the supervision entity of said current device being configured to create a container (805A) of relay connector (303B) and
   sending a command to create a connector (303C) container (805C) to the next relay device;
      the creation of the connectors on the current device and on the next relay device being synchronized according to a mechanism of acknowledgement message exchange between the devices.

According to one aspect of the invention, the mechanism of synchronization between the supervision entity of the next device and of the current device in the route between the source device and the target device comprises:
the dispatching of a synchronization message to the supervision entity of the current device
in response to the creation of the other end of the connector on the next device, the dispatching of a message of acknowledgement by the supervision entity of the next device to the supervision entity of the current device.

In response to the creation of the other end of the connector on the next device, the supervision entity of the next device can furthermore create a software interface for receiving the data, and a software interface for acknowledgements.

In response to the receipt of the message of acknowledgement by the supervision entity of the source device, the supervision entity of the current device can create a software interface for dispatching data and an acknowledgement reception software interface.

The supervision entity of the target device can furthermore create a mailbox for storing the synchronization messages arriving from other supervision entities.

According to a characteristic of the invention, the supervision entities can encapsulate the data exchanged between the components in an encapsulation class.

If a device hosting a connector which receives encapsulated data does not locally have the class of the objects, the connector then manipulates only the data of the encapsulation class.

If a device hosting a connector which receives encapsulated data does locally have the class of the objects, the container of connector can then extract the encapsulation class of the contained object.

According to another characteristic of the invention, the objects exchanged between components are serialized.

The supervision system according to the invention thus makes it possible to establish connections between the components and to support communication between the devices which can dialogue with one another through these connections. Moreover, the supervision system according to the invention makes it possible to move or to replace a component, in a transparent manner, without the components which communicate with this component needing to be informed thereof. Thus, the components related to a moved or replaced component can continue to operate, without being impacted.

### BRIEF DESCRIPTION OF THE DRAWINGS

Other characteristics and advantages of the invention will become apparent on reading the detailed description which follows and the figures of the appended drawings in which:

FIG. 1 is a diagram representing the general architecture of the supervision system according to an embodiment of the invention;

FIG. 2 represents examples of devices hosting components controlled by the supervision system, according to embodiments of the invention;

FIG. 3 shows the structure of the application;

FIG. 4 is a diagram showing the structure of a component model according to certain embodiments of the invention;

FIG. 5 illustrates the life cycle of a Component, according to certain embodiments of the invention;

FIG. 6 is a diagram showing the structure of a component container, according to an embodiment of the invention;

FIG. 7 represents a diagram of states of an output unit, according to an embodiment of the invention;

FIG. 8 is a structural diagram of a model of a Connector supported by the supervision system according to an embodiment of the invention;

FIG. 9 represents an Internal connector, according to an embodiment of the invention;

FIG. 10 represents a distributed connector, according to an embodiment of the invention;

FIG. 11 is a flowchart representing the creation of a distributed connector according to an embodiment of the invention;

FIG. 12 is a flowchart representing the deletion of a distributed connector according to an embodiment of the invention;

FIG. 13 represents a relay connector of the supervision system according to an embodiment of the invention;

FIG. 14 is a flowchart representing the creation of a distributed connector according to an embodiment of the invention;

FIG. 15 is a table illustrating the redirection of connectors as a function of the configurations of the connectors, according to certain embodiments of the invention;

FIG. 16 illustrates the communication between the supervision entities;

FIG. 17 is a diagram representing the mechanism for synchronizing the connectors according to the embodiments of the invention; and

FIG. 18 represents the architecture of the kernel of the supervision system.

### DETAILED DESCRIPTION

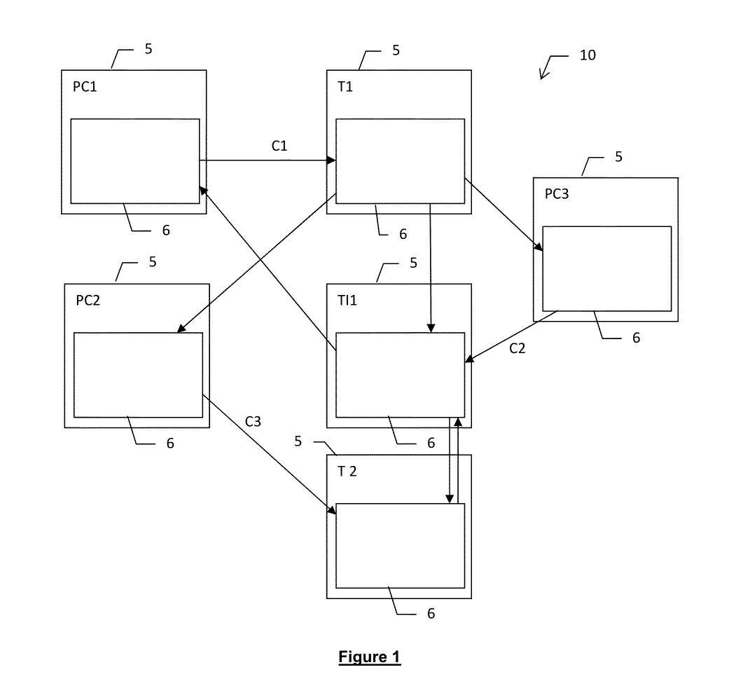

FIG. 1 represents a system for supervising applications 10 implementing the dynamic loading process according to the embodiments of the invention. The supervision system 10 represented is a dynamic and decentralized system for controlling the applications of a set of electronic devices 5 connected together by communication networks, for example of WIFI or satellite type (GSM, 3G, 4G, etc.). The electronic devices (also designated by the expressions “host devices” or “hosts” or “machines” in the subsequent description) can comprise any type of electronic device, notably mobile electronic devices, such as personal computers such as PC1 and PC2, intelligent mobile telephones (called “Smartphones”) such as T1 and T2, computer tablets such as TI1, etc. The communication networks supported by the electronic devices 5 can comprise several types of networks.

According to this decentralized approach, the supervision system 10 comprises a set of supervision entities 6 (also called “local supervision entities”), each hosted on a respective electronic device 5. The supervision entities cooperate together to dynamically supervise the application components which execute on the set of devices 5 as a function of context and of resources. These supervision entities dynamically control the life cycle of the components which can comprise the creation of a component on a device, the deletion of a component from a device 5 or the migration of an application component between a source device and a target device, notably to take account of the context of execution and the hardware resources. The local supervision entities 6 can furthermore be configured to collect information on the use of the hardware resources of the electronic devices, such as the battery, the memory or the CPU (the acronym standing for the expression “Central Processing Unit”), and/or the context of execution, represented for example by the network, the needs of the users, or the rules of use of the application, etc. The local supervision entities 6 can then dynamically trigger actions for reconfiguring the application components which execute on the electronic devices 5 in a user transparent manner according to a decentralized approach (no central server is required). Such reconfiguration allows the dynamic deployment and redeployment of applications and can notably involve the creation, the deletion or the migration of components. The components (C1, C2, C3) can thus be migrated from device to device, in an independent manner, whatever the type of the source device and of the reception device as a function of the context of execution and/or of the hardware resources, while pursuing their execution on each device which receives them (warm rebooting).

The supervision system 10 according to the invention makes it possible notably to ensure service continuity in case of unavailability of an electronic device 5. In particular, in case of malfunction of a device, the supervision entities 6 can provide the application with everything it expects while future-proofing to the maximum its execution and while anticipating critical situations which may be related for example to the lifetime of a battery or the exceeding of the available bandwidth. The supervision system 10 makes it possible notably to distribute the load of the application over neighbouring electronic devices 5, and to optimize the distribution of the components of the application over the neighbouring electronic devices, when the device 5 on which the application executes is confronted with problems of resources, such as disconnections due to the discharging of the battery.

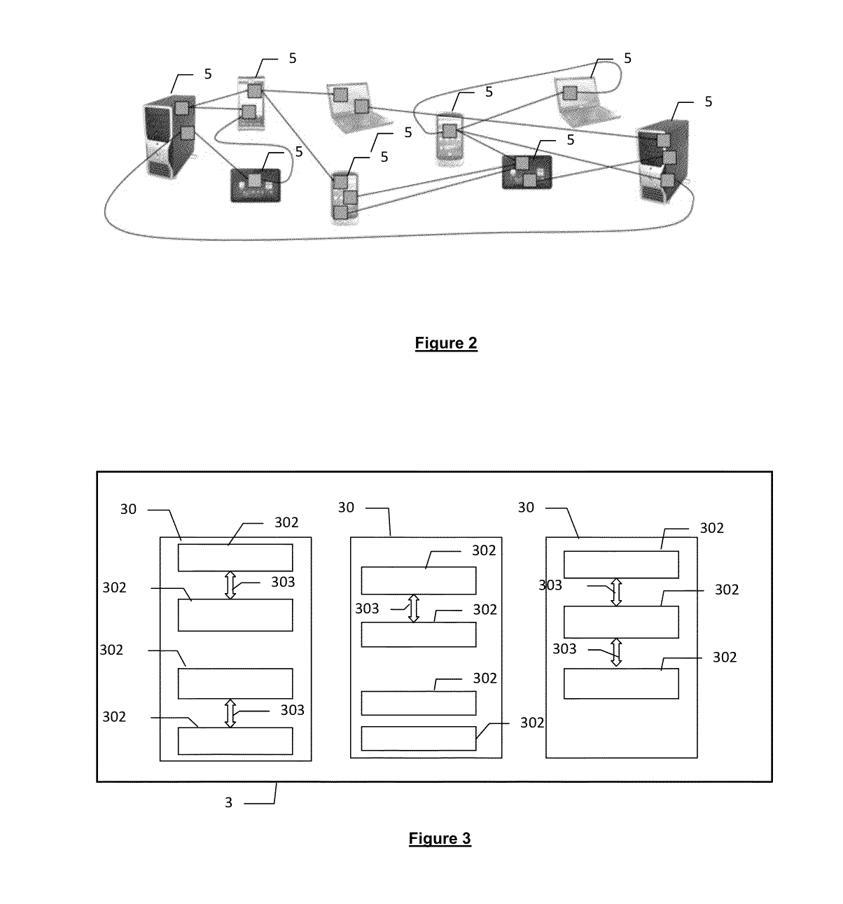

FIG. 2 shows examples of devices 5, of different types, executing applications controlled by the supervision system (not represented in the figure) according to the invention. An application can be composed of one or more services and each service can be carried out by one or more assemblages of components (represented by the hatched squares) linked by connectors (represented by the arrowed lines). The state of an application thus consists of the set of states of the components, devices 5, connectors between the components and of the environment. The supervision entities 6 are configured to gather such data so as to process them and to trigger appropriate reconfiguration commands. In response to these reconfiguration commands, the supervision entities can cooperate with one another to modify the general architecture of the application (possibly involving a modification of the distribution of the components over the set of devices involved in the application), by migrating components (hatched squares) from one device 5 to another according to a migration process, and/or by replacing one or more components with others.

The supervision system 10 according to the invention thus allows the dynamic deployment and the dynamic reconfiguration of applications on a whole set of devices that may include any type of electronic device 5 (laptop computer, computer tablet, intelligent telephones, etc.), whatever communication network it supports.

FIG. 3 represents the general structure of applications 3 controlled by the supervision system 10. Modular applications 3 based on distributed software components can be executed on the devices 5. The resulting modularity makes it possible to propose warm-reconfigurable, ad hoc solutions which guarantee the continuity of the applications and their future-proofing.

Each application 3 according to the invention comprises a set of interconnected functionalities 30. Each functionality itself consists of a set of software components 302 linked by connectors 303. These functionalities 30 can be carried out in various ways on the basis of assemblages of different components 302. The supervision system 10 therefore utilizes several functional decompositions corresponding to the diverse configurations of the architecture.

In order to be able to adapt dynamically, each application 3 has a reflexivity capability which allows it to have awareness of itself. This reflexivity capability allows it to replace a service which is defective or ill-adapted to the current context with another service.

For this purpose, the supervision system 10 is configured to acquire awareness of the application in progress as well as the context of the application in a dynamic and transparent manner.

The supervision system can be used for example to supervise an application for taking notes destined for the gardeners of a botanical park each equipped with devices 5, so as to allow them to monitor the plants and their progress (taking of pictures, taking of notes, location, etc.). The application can be hosted on intelligent telephones 5 (smartphones) allowing the gardeners to take geolocated notes, written or verbal. Each plant is accompanied by a bar-code identifier panel of QR code type (the acronym standing for the expression “Quick Response”), the reading of these QR codes facilitating the designation of the plants in the notes. For practical reasons (position of the note taker with respect to the panel), the reading of the QR codes can be delegated to another gardener. It is also possible to allow another gardener to complete a note taking.

When a gardener arrives in the park and has an intelligent telephone hosting a currently executing local supervision entity 6, an MMI (Man Machine Interface) component can be deployed thereto, offering 3 buttons: Edit/Select a note, record a voice note, activate geolocation.

If he selects the first button, a component C1 for choosing a written or verbal note is deployed allowing him to select an already present note while a component C2 for accessing the database of notes is deployed on the central server of the park. These two components C1 and C2 are connected together by connectors. If the gardener chooses a written note, an edit component C3 is deployed. When he wishes to introduce a QR code reading (scan) into his note, he is prompted with the list of devices of the other gardeners present in the park. He can then choose to scan the note himself or to delegate this task to one of his colleagues. In the latter case, an alert component (vibrator and message) C4 is deployed on this colleague's terminal so as to warn him of the request. If the colleague accepts, this alert component C4 is replaced with a QR code reading component C5 which is linked by connector to the first gardener's note taking component C6. As soon as the code has been read and the result inserted into the note, the reading (scan) component and the connector are automatically deleted.

If the gardener has turned geolocation on, when he saves his note on the server of the park, it will be able to be geolocated automatically. During a subsequent consultation of this note, this geolocation as well as the date will be accessible.

An application thus consists of software components 302 linked by connectors 303. The architecture of an application is designed during execution and can be modified while the application is executing without it being necessary to stop it (warm reconfiguration).

The supervision entities 6 cooperate with one another to add, delete, connect, disconnect or migrate the components of each application. During its execution, each supervision entity can furthermore collect information on the state of the application in the course of execution, in particular information relating to the components, to the connectors connecting the components, to the host devices 5. As a supplement, a user interface can be provided to allow the management of the supervision entities on each device involved in a given application.

The applications supervised by the supervision system 10 are thus distributed over the set of devices 5. However, in contradistinction to the conventional approaches, they are not dependent on the existence of central servers. Each device 5 can dialogue directly with the other devices through connections between the components which are established by the supervision system 10. The supervision system 10 can thus move or replace a component, without it being necessary to inform the components which communicate with it thereof. The linked components can then continue to operate in a totally identical manner.

However, the movement of a component from one host to another makes it necessary to follow the network links (via the connectors) which are established from the moved component and to this component. No, such a movement may make it necessary to change network interface (for example, to switch from wifi to 3G or 4G). Moreover, to ensure dynamic operation of the supervision system, the operations linked with such a movement of the component must be done in a manner totally transparent to the components in conjunction with the migrated component.

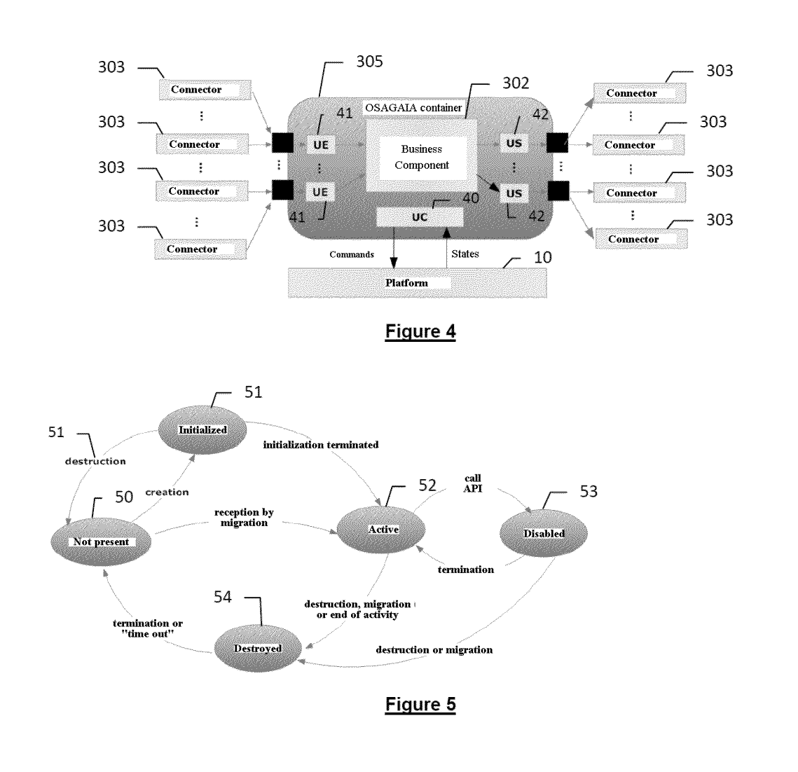

FIG. 4 illustrates the interactions between the components 302 and connectors 303 according to certain aspects of the invention. The supervision system 10 forms a supervision platform which is distributed over the devices 5 so as to be aware of the components 302 and connectors 303 deployed. It is furthermore configured to recover the context information that the latter transmit to it. As a function of this information, the supervision system 10 may determine whether reconfigurations must be implemented, involving component dynamic deployment and redeployment.

The supervision system 10 uses containers 305 to monitor the operation of the components 302 and the flow of the data streams between the components 302 connected by the connectors 303. The containers 305 are configured to gather the information between the entities 302 and 303. They furthermore make it possible to manage the hardware and software heterogeneity of the devices 5 as well as the mobility of the devices.

FIG. 4 shows more precisely a model of container 305 for a component 302 of Business Component type. In the subsequent description, the terms “business components”, “application components”, “software components”, or simply “components” may be used in a similar manner to designate a component. According to this model of container 305, the business logic contained in a component is separated from the supervision managed by a container. The Component 302 can receive several data streams as input and produce several data streams as output. Moreover, each output stream can be duplicated. The container 305 represented encapsulates a single component 302 and can implement a set of non-functional properties, such as life cycle management, quality of service information recovery and communications management. The container 305 associated with a component on a device is created by the supervision entity 6 which receives the component, while the code associated with the component can be loaded dynamically.

The container 305 possesses three unit types:
One or more input units (UE) designated by the reference 41 for receiving the data item streams at input,
One or more output units (US) designated by the reference 42 for receiving the data item streams at output, and
A Control unit (UC) designated by the reference 40.

The input units UE 41 and the output units US 42 can be connected to one or to several connectors 303. These units 41 and 42 allow the Component 302 to read and to write data originating from other components or destined for other components. The component 302 can thus read data via the input units 41, perform its processing and write the results to the output units US 42. The supervision system 10 uses the control unit 40 (UC) to supervise the component container 305. Each component 302 container 305 can indeed register its control unit 40 as a service with the supervision entity of the device hosting the component, so as to allow the supervision entity 6 to control the various phases of the life cycle of the component.

The control unit 40 controls the elements of the component container 305. For example, the behaviour of the component can be controlled by the control unit 40 by means of a component initialization method (called init( ), of a component deletion method (called “destroy”) or else of a component activation method (called “Run_BC”). The input and output units 40 and 41 control the flow of the data in the container 305 and give the component access to its input and output streams.

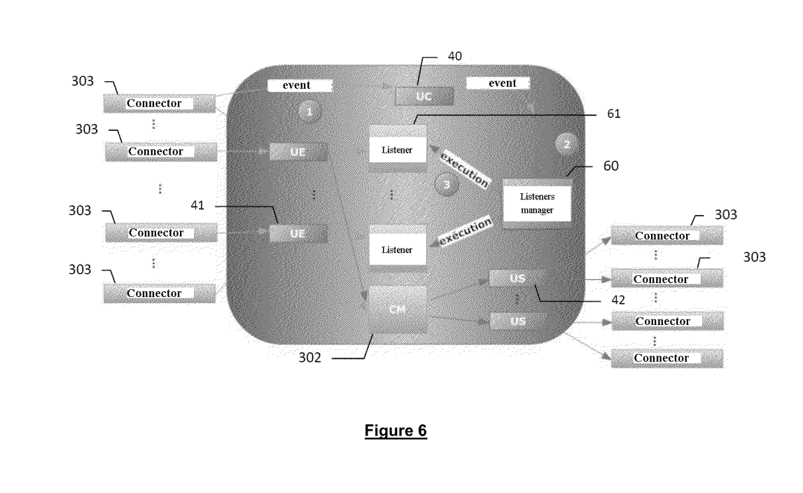

FIG. 5 illustrates the life cycle of a component 302. The components associated with a given application are initially written by the designer of the application. The supervision system 10 then encapsulates the component 302 in a container 305 which will control the life cycle thereof. The life cycle of a component corresponds to the calling of overloaded methods. This life cycle is similar to that of an “applet” (term designating a piece of software which executes in the window of a Web browser), of a MIDlet (the acronym standing for “Mobile Information Device applet” and designating a program installed in a mobile information device) or of an activity of the Android operating system.

The life cycle of a component 302 corresponds to the three types of actions implemented by the supervision entities 6: the creation of a component on a host machine, the deletion of a component on a host machine and the migration of a component between two host machines linked in a network.

The creation of a component 302 comprises the instantiation of an object of the class associated with the component, the encapsulation of this object in a container 305 and then the connection of its input and output streams.

The deletion of a component 302 comprises the stopping of the encapsulated component and then the deletion of its container 305. Its input/output streams can remain on standby awaiting a new component or awaiting deletion in their turn.

The migration of a component is implemented when a component 302 executing on a host A must be migrated to a host B. The supervision entity 6 hosted on the host A then stops the component at the level of the host A as during a deletion, and then dispatches the component to the supervision entity on the host B by using a mechanism for serializing the properties of the component, if the device B does not have the code associated with the component. The supervision entity 6 thereafter diverts the set of connectors 303 connected to this component 302 to their new destinations consisting of the host B. The component 502 received at B is encapsulated in a container 305 and then the supervision entity 6 reconnects the input and output streams of the component.

When a component 302 is created, it passes from the “non-present” state, designated by the reference 60, to the “Initialised” state, designated by the reference 61, where it executes an initialization method called “Init”. It thereafter passes to the “Active” state, designated by the reference 62, where it executes an execution method called “run_BC”. A component can also pass directly from the “non-present” state (60) to the “active” state (61) when it is received on the electronic device 5 subsequent to a migration. In this case the component is warm booted in the same state as it was in previously on the source device from which it was migrated, so that no initialization phase is required. During calls of functions of the programming interface API (the acronym standing for the expression “Application Programming Interface”), comprising for example functions such as read, write, services of the supervision system, the component can be placed in a “Disabled” state, designated by the reference 63. From the Active state 62 and the Disabled state 63, the component 302 can be stopped and placed in the “Destroyed” state (state 64) where it executes a method called “Destroy”. A component 302 can pass from the active state 62 to the destroyed state 64 if it is at the end of the activity or has been migrated to another device. A component can notably pass from the “disabled” state 63 to the “destroyed” state 64 on a given device 5, during a migration to another electronic device 5. The transitions between the states 50 to 54 are caused by exceptions. An exception designates an interruption of the execution of a program in response to a specific event that may entail a change of state.

According to a characteristic of the invention, two exception classes can be used:
A first class called “StopBCException” which represents an exception which can be used during reading or writing attempts or during access to the services of the supervision system (passage from the active state 52 to the disabled state 53).
A second class called “InterruptedException” which can be used to cause changes of state when a component 302 is in the disabled state 53 on a semaphore or is suspended.

After the execution of the “Destroy” method (in the “destroyed” state 54) or after a predefined time span, if the execution of the “Destroy” method does not terminate, the component 302 can be destroyed or migrated. During a migration of the component 302, its properties may be serialized, then on the new reception electronic device 5, it may be placed directly in the Active state 52.

In a preferred embodiment of the invention, the application part (comprising notably the code of the classes of the components and objects exchanged) is not resident on the mobile electronic devices so as to limit the overload of the devices 5. The classes of a component 302 are then loaded dynamically during the creation of the first instance of the component on a device and deleted during the deletion of its last instance on the component. Accordingly, the supervision entity 6 which receives a new component (creation or migration) can dispatch messages requesting the code file associated with the component to the other supervision entities 6 and load the classes of the component on the basis of the code file, if it has been returned by one of the supervision entities 6 on the other devices, by using a classes loader created for the file associated with the component. Moreover, so as not to needlessly occupy memory space, the code associated with a component (notably classes of the component) can be deleted from the device if no other instance of the component 302 uses it. A component 302 may comprise several classes and can include resources (for example images, sounds, etc.) and libraries. The executable code associated with the component can then comprise the binary code (“byte code”) of each class necessary for the operation of the component 302 (including libraries) and classes of the objects exchanged between components.

FIG. 6 shows the interactions between connectors 303 and a component 302 to which they are linked, according to an exemplary embodiment of the invention.

A component 302 can access its input and output streams by way of mechanisms provided by its container 305. In one embodiment of the invention, the data read as inputs or written as outputs of a component can be serializable objects which can be predefined by the designer. As the streams can transport continuous data (temporally continuous series of data arriving at regular time intervals) or discontinuous data (information not arriving at regular time intervals), the supervision system 10 may support two types of data access means, the first access means being suitable for continuous streams and the second access means being suitable for non-continuous streams.

The first access means allows direct access to the data. The component 302 can read from the stream of its choice by a disabling operation until a data item is available: the execution of the component is suspended until the data item is available, while the other components can continue to execute. As a variant, the component 302 can recover the first data item available in one of its input streams through an operation which disables it until a data item is available on one of the input streams. The second access means allows access to the data using listeners. According to this second access means, the component 302 puts in place on a stream an input listener 61, a method of which will be called automatically as soon as a data item is present on this stream. The listeners 61 may be placed on certain inputs only, on all the inputs or else on none. An input listener may be deleted at any moment by the component 302 which will then return to the first access means (direct access mode).

Writing to an output stream by a component 302 is done by a direct access operation which may be disabling only if no stream is connected to the corresponding output.

In an embodiment of the invention, when an input connector 303 has a new data item, it so informs the Control unit (UC) 40 of the container (1) which transmits this information item to a listeners manager 60 of the component 302. The listeners manager 60 is adapted for managing a queue waiting for the listeners of the component to be activated (2) and for executing the appropriate methods of these listeners (3). When the component 302 must be stopped, for example because it is migrated onto another device (step 602 of FIG. 6), the supervision entity 6 of the device on which the component is executing can stop the listeners manager 60 by using the same mechanisms as the component itself (exceptions) so that the data of the connectors 303 are no longer processed. Accordingly, the listeners manager may be configured so that it no longer launches any listeners to process the input data. These data therefore remain in the connector 303 and can be recovered by the next component which will be connected to this connector. In direct access mode (absence of listeners), the supervision entity 6 of the device hosting a component stops the component to be migrated by communicating with the control unit of the component. The control unit 40 of the component then stops the input units 40 of the component. The input data then also remain in the input connectors 303 and can be reused after the reconnection of the connectors.

The booting of a component 302 by the supervision entity 6 of the device on which the component executes is not tied to the existence of the connectors 303 which are connected to it. The execution of a component 302 can continue as long as it does not attempt to access an input or output stream.

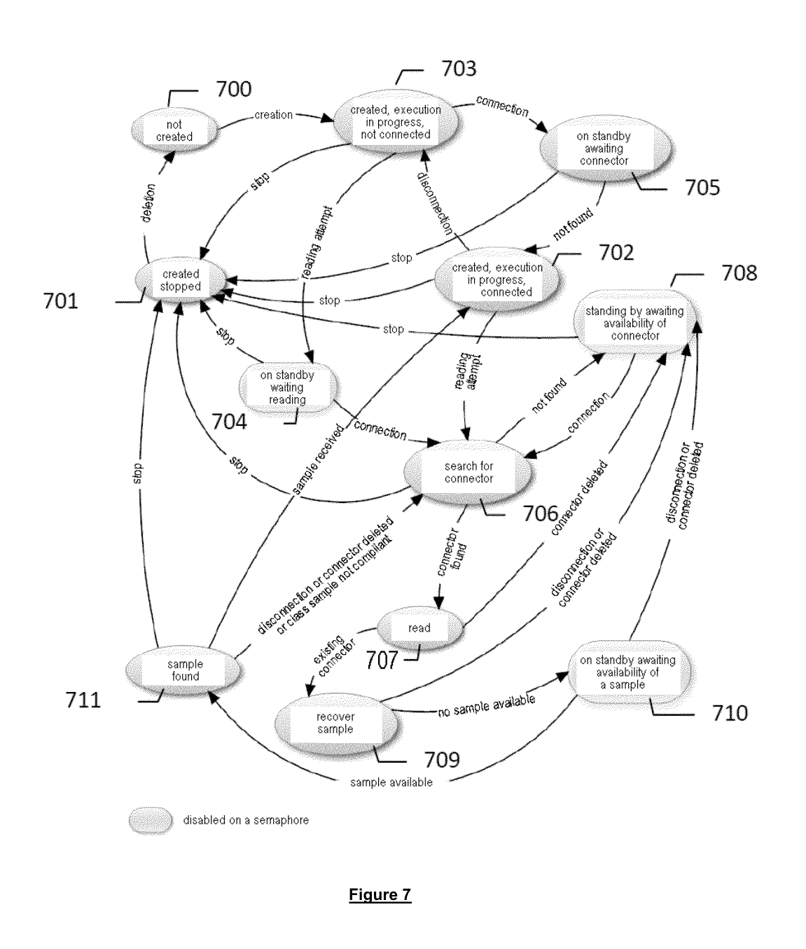

FIG. 7 shows the diagram of states of the input unit 41 of a container 305 of a component 302.

The operation of the input streams is managed by the input units 41 of the container 305 of the component 302. An input unit (UE) 41 can be in a “non-created” state (state 700). A created input unit can be “stopped” (state 701), “running and connected” (state 702), or else “running and unconnected” (state 703). When a created input unit 41 is stopped (state 701), a reading attempt by the component 302 on the input stream of this input unit causes an exception which stops the component. This exception procedure provided by the components container 305 consists in stopping the component 302 and then in making it execute its destruction method (“destroy”) so that it terminates as envisaged by the designer of the component. Thus, when a component 302 must be migrated (or more generally stopped), the supervision entity 10 of the target device places all its input and output units (41, 42) into “stopped” mode (state 700). When an input unit 41 is running (i.e. the input unit is currently executing), it may be connected to a connector 303 (state 702) or not connected to a connector 303 (state 703). When it is not connected to a connector (state 703) it can either be stopped (state 700), or placed on reading standby in the case of a reading attempt by the component 302 on the input stream of the input unit (state 704), or placed on connection standby (state 705).

On each reading attempt by the component 302 from the state 701, the input unit 41 passes to the reading standby state 704, and then verifies whether it is connected to a connector 303 (connection search state 706). If it is connected to a connector 303, the input unit 41 attempts to recover a data item (reading state 707). Otherwise, if it is not connected to any connector (standby state 708 awaiting connector availability), the input unit 41 disables the component 302 until the former is again connected to a connector (return to state 706) or until the supervision system 10 stops the input unit 41 (state 701).

During a reading attempt in a connector 303 at input (state 707), after the input unit 41 has identified a connection with this connector 303 (state 706), the component 302 is disabled until a data item is present on the input connecting it to the connector 303. While the component 302 is disabled, the input unit 41 verifies that the connector 303 remains present. If the connector 303 disappears or is disconnected from this input 41 whilst the component 302 is disabled, the input unit 41 suspends the reading in progress and waits for a new connection to be effected (standby state 708 awaiting connector availability). As soon as such a connection is established, the input unit resumes the suspended reading (return to the state 707).

When a data item is present on the input connecting the input unit to the connector 303, the input unit 41 passes to the state 709 to attempt to recover data. If no data item is available, the input unit passes to standby state (state 710) until a data item is available (state 711). When a data item is available, the input unit can either be stopped (state 701) or return to the state 702 until the next data item reading attempt.

As a supplement, the supervision system 10 can stop the component 302 at any moment. Semaphores can be used so as to block a component 302 and allow the execution of the other components while one of them is on standby awaiting either a connector or a data item.

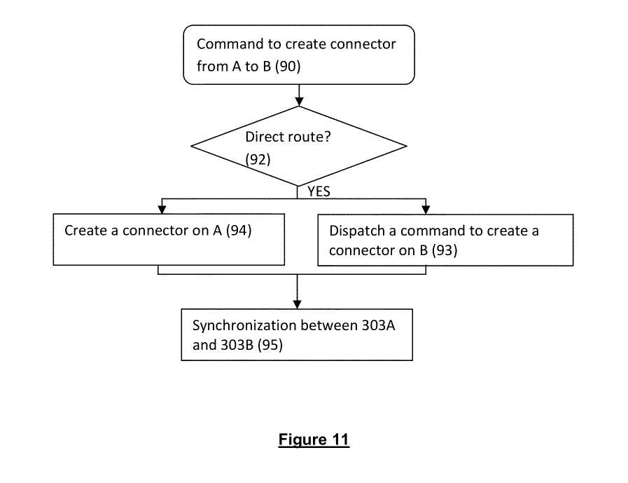

The state diagram of FIG. 10 applies in a similar manner to the output units 42. The output streams originating from a component 302 can be duplicated as many times as necessary to be transmitted to several components which are connected to it. This duplication is totally transparent to the components 302 so that the addition or the removal of a connector 303 does not have any impact on its operation. When there is no longer any stream output by an output unit 42, the component 302 is disabled as soon as it attempts to produce a data item on this output. It is automatically relaunched immediately upon the connection of a new connector and then the data item on standby is written thereto. Like the input units 41, the output units 42 can be stopped or running, connected or unconnected. When an output unit is stopped, a writing attempt by the component 302 causes an exception which stops it in its turn.

This mode of operation makes it possible to delete, disconnect or reconnect input/output streams, in a dynamic manner, without disturbing the operation of the components 302, which are suspended when they attempt to access the input/output streams, and relaunched when the input/output streams are available again. This capability of dynamic connection/disconnection of the input/output streams is particularly suitable for mobile environments where such situations can occur frequently.

The control unit 40 of the component container 305 constitutes the connection between the component container and the supervision entity 6. In particular, each supervision entity 6 can communicate with the control unit 40 of the container 305 of a component so as to toggle an input unit 40 or an output unit 41 of the component to the stopped state when the former wishes to stop the component. Each supervision entity 6 can furthermore communicate with the control unit 40 of the container 305 of a component so as to gather information on the activity of the component.

FIG. 8 represents the general structure of a model of connector 303 which makes it possible to link two components 302, according to an embodiment of the invention.

According to this embodiment, a connector 303 can be encapsulated by containers 805. The main functionality of a connector 303 is to link two components 302 together and to make the information flow between them. In the same manner as a component 302, a connector 303 constitutes an element of first class (element that can be created or destroyed dynamically). The connectors 303 are not limited to the implementation of one or more specific modes of communication (for example of Client/Server, Pipe & Filter type, etc.). Moreover, a connector 303 can act on the information exchanged between two components so as to adapt (technically or semantically) the data. Accordingly, each connector 303 can itself comprise a business component 802. Thus, the component 802 contained in a connector can not only make the information flow but can also modify it on passing, for example by enciphering or by compressing the data before transmitting them.

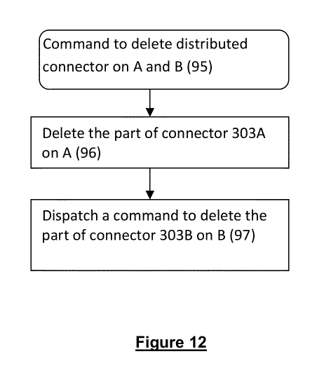

As shown in FIG. 11, a connector 303 can be encapsulated in a container 805 endowed with an input unit (UE) 81, with an output unit (US) 82 and with a control unit (UC) 80 in a manner analogous to the container 305 of a business component 302. However, in contradistinction to the business container 305 of a component 302, the connector 303 container 805 accepts only a single input unit 81 and only a single output unit 82. Moreover, the control unit (UC) 80 allows the supervision system 10 to supervise the operation of the connector 303. The input unit (UE) 81 and the one output unit (US) 82 can be connected to buffers respectively 810 and 820 to avoid data losses during reconfigurations. The data are stored in the buffers 810 and 820 until they can be transferred. Furthermore, the buffers 810 and 820 make it possible to detect situations that may necessitate reconfigurations of the components 302 on the whole set of mobile devices 5, for example by migration of certain components 302 between the mobile devices. Thus, if an output buffer 820 is saturated, the control unit 80 detects that the next component is not processing the data fast enough or that the network link is slow. If an input buffer 810 is saturated, the control unit 80 detects a malfunction of the component 802 contained in the connector 303. Moreover, if the buffers 810 and 820 are empty, this allows the control unit 80 to detect the fluidity of the flow of the data and to dynamically trigger a reconfiguration of the components 302 on the whole set of devices 5 so as to increase the quality of the service.

Thus, the component 802 encapsulated in the connector 303 ensures the transfer of data between the input unit 81 and the output unit 82. It can apply any type of process oriented communication (compression, rules of priority between the data, aggregation of the data, etc.). The component 802 is essentially provided to read a sample of data from the input unit 81 and write it to the output unit 82.

The connector 303 is configured to inform the supervision entity 6 of the device on which it is executing 5 (**verify) of the state of the flow of the data in the application. It is furthermore adapted for raising alarms when data accumulate in its buffers 810 and 820 and also when the flow of the data becomes fluid after an accumulation in the buffers 810 and 820. The supervision system 10 can thus monitor the flow of data in a host 5 or between two hosts 5 on the network. The levels of the alarms are parametrizable in the supervision system 10.

The supervision entity 6 can communicate with the control unit 80 of the connectors hosted on the same device to receive alerts. The control unit 80 emits such alarms as a function of the state of the buffers 810 and 820. On the basis of the alerts received, the supervision entity 6 can trigger reconfigurations which modify the mapping of the components on the whole set of devices in a transparent manner.

The connectors 303 thus correspond to data streams which can also be encapsulated in containers 805. These containers 805 of connectors allow the supervision system to perform dynamic deployments and reconfigurations during the execution of the application. The connectors themselves form components capable of controlling the transfer of the data. They allow notably the local supervision entity to control the state of the information which flows between the components.

According to one aspect of the present invention, the connectors 303 can operate in synchronous mode. Thus, for each data item dispatched an acknowledgement is returned. No new data item can be dispatched as long as the acknowledgement has not been received. This synchronization mechanism allows the supervision system 10 to control and/or to measure the flow of the data. Thus, no data item can be accumulated outside of its “middleware”, for example in the buffer memories (“buffers”) of the network connectors (or “sockets”, as they are also called).

A connector 303 can be used to link two components 302 on the same electronic device 5 (internal connector). As a variant, a connector 303 can be used to link two components 302 placed on different electronic devices 5 (distributed connector). Because of the heterogeneity of the networks (Ethernet, WiFi, Bluetooth, 3G, etc.) which can be used on the whole set of electronic devices 5 covered by the supervision system 10, it may happen that two devices 5 that have to be linked by a connector 303 cannot communicate directly. The supervision system 10 is then configured to find an intermediate mobile device 5 that can serve as gateway between the two types of networks.

Thus, the supervision system 10 supports three types of connectors according to the following definitions: internal connectors, distributed connectors and relay connectors.

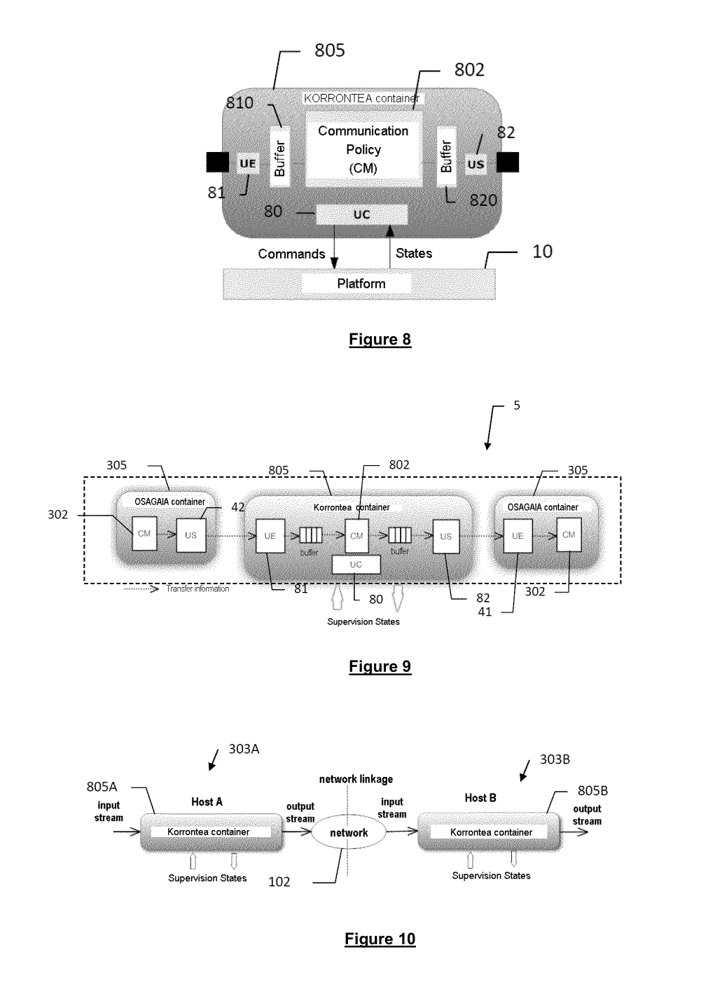

FIG. 9 represents an internal connector 303. The connector 303 is internal to a host 5 which links two components 302 on the same electronic device 5. When the supervision system 10 determines that two components 302 must be linked, the local supervision entity 6 on the device 5 creates a connector 303 container 805 on the device 5 and links it to the respective containers 305 of the two components 302, so that the input unit 81 of the resulting connector 303 is connected to the output unit 42 of one of the components and the output unit 82 of the connector 303 is connected to the input unit 41 of the other component 302.

FIG. 10 represents a distributed connector 303 for linking two components 302 located on two distinct hosts A and B, such as for example two distinct intelligent telephones (“smartphones”), two distinct laptop computers (PC), or else an intelligent telephone and a laptop computer, etc., when the two hosts have compatible communication means (the two hosts can communicate directly by network). The distributed connector 303 then establishes a communication by network 102 to connect the components 302.

FIG. 11 is a flowchart illustrating the processing of a command to create a distributed connector between a host A and a host B by the supervision entity 6 on the host A, when the hosts A and B have compatible communication means. When the supervision entity 6 on the host A receives a command to create a connector from the host A to the host B (step 90), it determines a route to B. If the route to B thus determined is direct (step 92), that is to say it does not pass through intermediate hosts, the supervision entity 6 on the host A sends a command to the supervision entity 6 on the host B so that the former creates a container of connector 805B (step 93). On its side, the supervision entity 6 on the host A creates a container of connector 805A (step 94). The person skilled in the art will understand that steps 93 and 94 can be carried out substantially at the same time or successively. The resulting connector 303 is an element of two parts, 303A encapsulated by the container 805A and 303B encapsulated by the container 805B, with a client execution thread on one side (on the host B) and a server execution thread on the other side (on the host A). A synchronization mechanism is booted between these two execution threads so as to synchronize the two parts of the connector 303.

If the supervision entity 6 on the host B receives a command to create a connector from the host A to the host B, a process similar to that of FIG. 10A is implemented, swapping the roles of the host A and of the host B.

FIG. 12 is a flowchart illustrating the processing of a command to delete a distributed connector on a host A and a host B, by the supervision entity 6 on a host A.

In response to the receipt of a command to delete a distributed connector 303 (step 95), the supervision entity on the host A sends a command to the supervision entity 6 on the host B so that the former deletes the container 303 and the communication thread (step 96). On its side, the supervision entity on the host A deletes its own container 303 and its communication thread (step 97). The person skilled in the art will understand that steps 96 and 97 can be carried out substantially at the same time or successively.

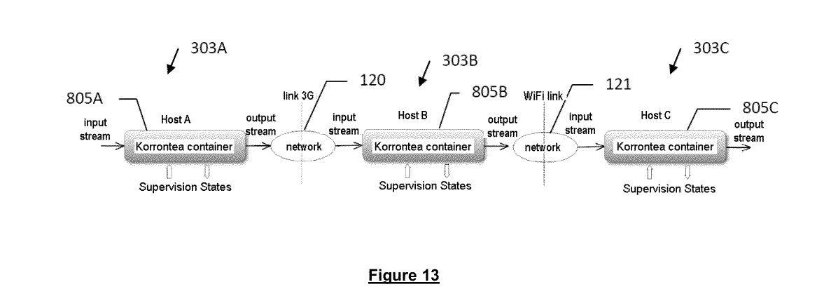

FIG. 13 illustrates the structure of a relay connector 303 which can be used to connect two components 302 placed respectively on two distinct hosts A and C which cannot communicate with one another. Such a situation occurs when the communication network 120 of the host A (for example 3G network) is incompatible with the communication network 121 of the host C (for example wifi network), that is to say there is no direct link between the hosts. In this case, a connector 303B on a relay host B can be used as relay on the network. The host relay B is chosen so as to be able to establish a direct link with A and another direct link with C. Such a connector 303B makes it possible to create bridges between two networks of different types (distinct of complex routes). Thus, to link two components 302 on two hosts using different networks, the supervision system 10 creates a connector 303B on a relay host B simultaneously having access to both networks 120 and 121.

The input unit 81 of the connector 303B on the relay host B is connected to the output unit 42 of the component 302 on the first host A and the output unit 82 of the connector 303B on the relay host B is connected to the input unit 41 of the component 302 on the second host C. The relay connector 303 thus takes the form of three parts 303A, 303B and 303C, and uses the same connection mechanisms as a distributed connector.

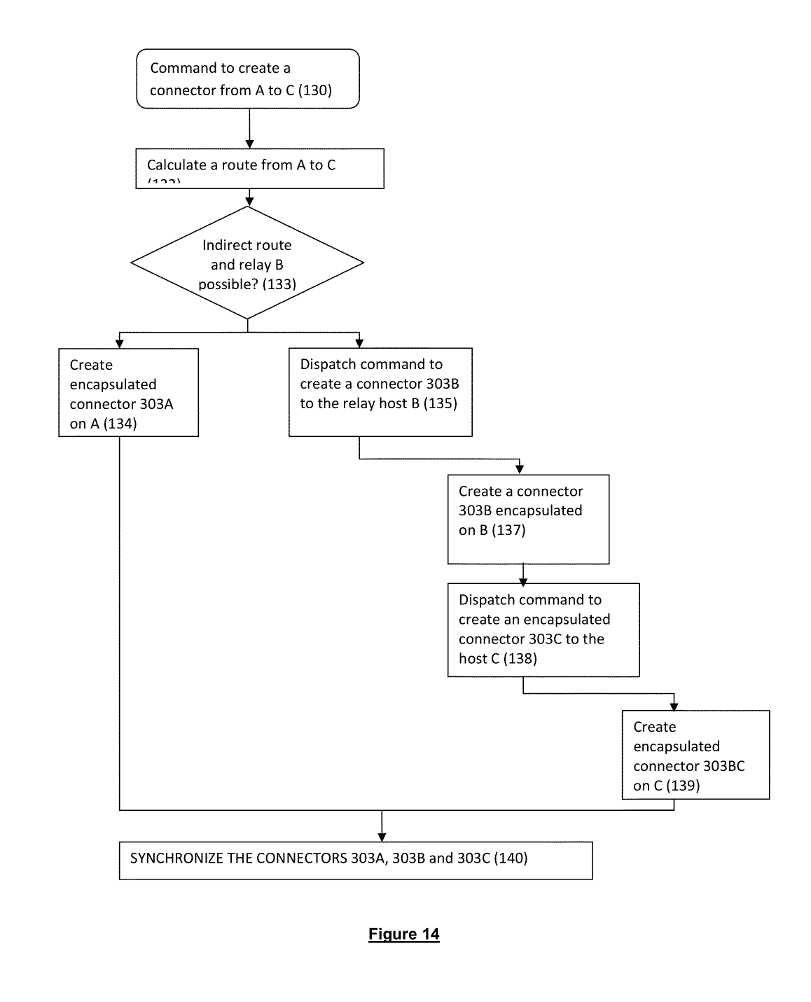

FIG. 14 is a flowchart of the steps implemented by the supervision entities to link two components 302 on two hosts A and C having incompatible communication means.

A command to create a new connector can be received by a supervision entity, for example to link two components, newly created or not, within the framework of a dynamically triggered reconfiguration action.

In response to a command to create a connector 303 between a host A and a host C (step 130), the supervision entity 6 on the host A calculates a route from A to C (step 132), if the command has been received by the host A. To detect the incompatibility of the networks, the host A executing the create command can attempt to reach the other host B, and if it does not succeed, determine that no direct link is possible between the hosts A and B. If the route thus determined is not direct (133) and passes through one or more hosts B that may serve as relay (134), the local supervision entity 6 on the host A sends a command to the local supervision entity 6 on the next relay host B on the route so that the former creates a connector 303B from B to C (step 135). The local supervision entity 6 on the relay host B creates a container of connector 805B encapsulating a connector 303B (137). On its side, the local supervision entity 6 on the host A creates a container of connector 805A on the host A encapsulating a connector 303A (134). The local supervision entity 6 on the current relay host B can in turn send a command to the local supervision entity 6 on the next relay host in the route and iterates the same processing between the previous current relay host B and the next relay host in the route until the target host C is reached.

The following description of FIG. 14 will be made on the assumption that there is a unique relay host B between the source host A and the target host C for illustration purpose only. The local supervision entity 6 on the relay host B may then send a command to the local supervision entity 6 on the target host C for the creation of a connector directly to the target host C.

The local supervision entity 6 on the host B may send in its turn a command to the local supervision entity 6 on the host C so that the former creates a container of connector 805C encapsulating a connector 303C (step 139). The local supervision entity 6 on the relay host C may then create a container of connector 805C encapsulating a connector 303C (137). A relay connector 303 with three parts 303A, 303B and 303C is thus created. A synchronization mechanism is thereafter implemented between the three parts 303A, 303B and 303C of the connector 303 (step 140) to synchronize these three parts.

In a particular embodiment of the invention, the devices 5 supervised by the supervision system 10 rely on an object language, preferably JAVA. The subsequent description will be made with reference to such an embodiment.

Each supervision entity 6 can control the communications between the components 302 by serialization of the objects exchanged. The middleware of the supervision entity thus comprises the set of connectors 303 and parts of the supervision entity charged with managing these connectors (for example to create them, delete them, etc.).

The supervision system 10 defines notably a class, hereinafter called “Sample”, from which the classes of the objects exchanged through the connectors 303 inherit. Information can be added to the data such as their date of creation and the stream on which the data were transported. This information can be added automatically by the supervision entity. This information can be used in various ways, for example, to prevent data considered to be out of date from being used.

When the code of the classes of the components and of the objects exchanged is not resident on each of the hosts 5 and is downloaded by request onto the device which receives a new component by the supervision system 10, the availability of the classes of components and of the objects exchanged on a given device depends on the creation of the component on this device 5. However, to be able to transport objects by serialization between components 302, the devices 5 hosting the components must have the classes of these objects. The serialization makes it possible to translate the properties constituting the state of an object into a format by allowing either the storage or the transport on a network link. Then to be able to reconstruct (including on another machine) the properties such as they were initially from the information set into this format.

When a connector 303 on a device 5 is connected to a component 302, the classes of the objects at input and output of the component 302 have been loaded beforehand with the component 302 within the framework of the creation or of the migration of the component on the host. The connector 303 thus has access to the classes of the objects.

However, as the supervision system 10 is distributed, it may happen that a connector 303 is created on a given device before the component 302 to which it is connected (case i), so that the device 5 does not have the code of the data associated with the component 302 during the creation of the connector 303. Indeed, as the creation of a connector 303 between a host A and a host B can be initiated by the host A or by the host B, the creation of the part 303A of the connector situated on A may arise for example subsequent to a command originating from the host B while the creation of the component 302 associated with this connector on the host A may be caused by a command originating from another host C distinct from the host B, for example because it implements a dynamic restructuration or reconfiguration of the application subsequent to a change of context. Accordingly, since the two commands received by the host A (command to create a connector 303A originating from the host B and command to create a component 302 originating from the host C) arise from two different machines, the order in which they reach the host A is unpredictable: thus, the host B could dispatch a data item on the connector 303A linking it to the host A before the host A actually has the code of the class of this data item.

Moreover, a connector 303 on a given host 5 might not be connected to any component 302 (case ii), as in the case of a relay connector including a connector 303B placed on a relay host B with the aim of linking two other hosts A and C not sharing the same network (FIG. 12). The code of the objects transported by the connector 303 has not then previously been loaded dynamically on the host where the connector was created, as the dynamic loading of the code associated with the component is triggered for the creation or the migration of a component on the host. In the absence of the code of the data, the host may not relay the data.

To remedy the situation, the supervision entities 6 may encapsulate the classes of the objects in a specific encapsulation class (designated hereinafter by “EncapsulatedSample”) so that the connectors 303 which do not have access to the classes of the data manipulate only objects of this “EncapsulatedSample” encapsulation class. The encapsulation of the data transmitted in a container provided for this purpose makes it possible to transport them and to receive them, even in the absence of the code of the classes of these data. These data can only be de-encapsulated and used on a device when their code is available on this device. It is thus possible to transport on connectors information whose code is not available locally. By this encapsulation, the sender component and the final recipient component of the data exchanged are capable of processing the data since these devices have the code of the classes of these data which has been dynamically loaded at the same time as the code of the component itself, at the moment of the creation of its first instance.

Thus, when the connector 303 is the connector 303B serving as relay between the other two parts of a relay connector (case ii), the role of this intermediate connector 303B is then limited to transmitting the encapsulated data. In the case of a connector 303 connected to a component 302 but created before the component 302 (case i), the connector 303 transmits the data item encapsulated in the “EncapsulatedSample” class to the input unit 81 of the container 805 of connector which can extract the object contained from the encapsulation class since the code of the class of this object has been loaded with the component 302 which processes it.

The central part of a relay connector is in general created when two devices having to communicate cannot establish any direct link. The role of the central parts of relay connectors consists essentially in making the encapsulated data flow without processing them. The application can thus operate as if this central part did not exist.

According to another aspect of the invention, the supervision entities 6 can control the redirection of the connectors as a function of the mobility of the components between the devices 5.

The creation of a connector 303 may culminate, according to the location of the components 302 that the connector links, in the creation of an internal connector, of a distributed connector or of a connector with relay. For example, when a component 302 is migrated from a host A to a host B, the component 302 is stopped on the host A and then serialized towards the host B and finally its input and output connectors 303 are redirected in such a way that they henceforth culminate on the host B rather than on the host A. The redirection of a connector 303, within the framework of a migration, may be implemented differently according to the type of connector and the location of the parts of connectors 303 before the migration of the component. The table of FIG. 15 presents various possible cases.

In CASE 1 corresponding to the creation on a host A of a connector 303 between two components on the host A (internal connector), the local supervision entity 6 creates an internal connector 303 on the host A.

In CASE 2 corresponding to the creation by a host A of a distributed connector 303 a host E and the host A, when the connection is direct between the host E and the host A, the local supervision entity 6 on the host A creates one part 303A of a distributed connector connected at input to the host E and requests E to create the other part of this connector (303E).

In CASE 3 corresponding to the creation by a host A of a connector 303 between a host E and the host A, when the indirect connection between E and A passes through an intermediate host HE, the local supervision entity 6 on the host A requests the intermediate host HE to create a relay connector 303HE from E to A and creates the local part 303A of the connector. HE requests E to create the other part 303E of the connector.

In CASE 4 corresponding to the creation by a host A of a connector 303 between the host A and a host S distinct from A, when the connection is direct between A and S, the host A creates a distributed connector 303A connected at output to the host S and requests S to create the other part 303S of the connector.

In CASE 5 corresponding to the creation by a host A of a connector 303 between a host E and a host S, both distinct from A, when the connection is direct between E and A on the one hand and S and A on the other hand, the supervision entity on the host A locally creates a relay connector 303A from E to S and requests E and S to create the other parts, 303E and 303S, of this connector.

In CASE 6 corresponding to the creation by a host A of a connector 303 between the host A and a host S, distinct from A, when the indirect connection between A and S passes through an intermediate host HS, the host A requests HS to create a relay connector 303HS from A to S and creates the local part 303 A of the connector. The host HS requests S to create the other part 303S of the connector.

In one embodiment of the invention, the communications ensured by the connectors 303 can use a client/server model. In particular, when a connector distributed over two distinct hosts A and B is created, it launches a synchronization process making it possible to check that the various parts of which it consists (connectors 303A and 303B) are ready. In the course of this process, mechanisms are put in place to allow the subsequent communication.

The synchronization mechanism is applied in an analogous manner between each end of a relay connector and the central part of a relay connector.

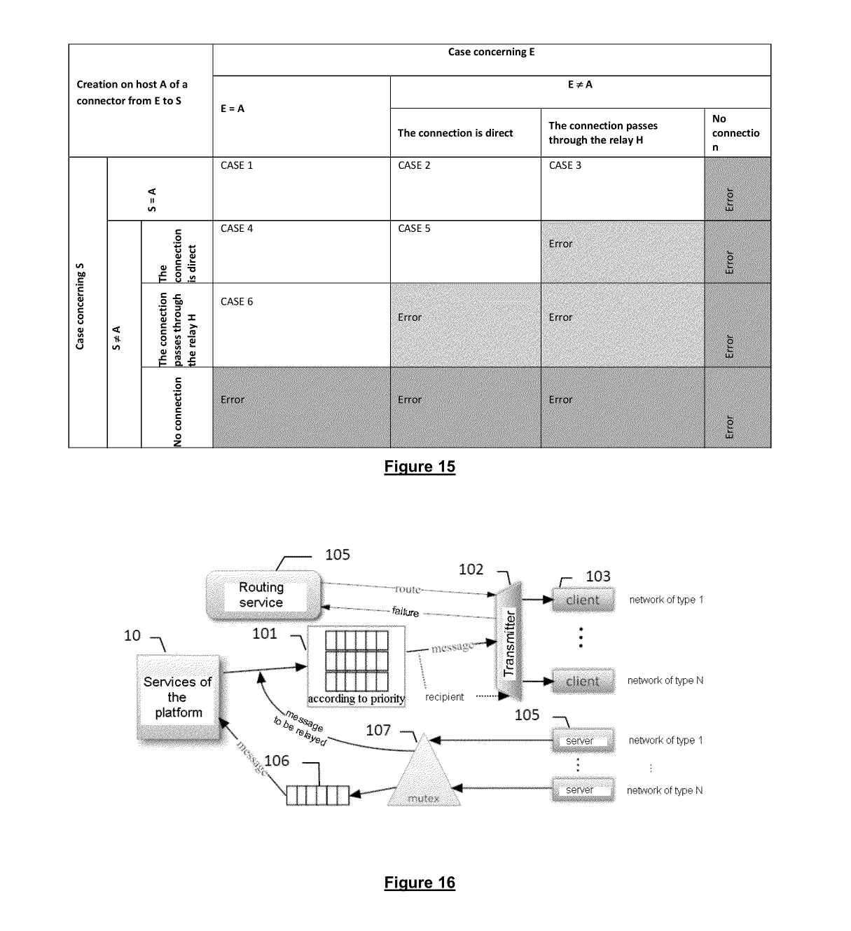

FIG. 16 represents the general communication structure allowing the entities to communicate with one another.

Each supervision entity 6 can comprise one or more queues 101 to store the incoming or outgoing messages. These queues allow the various services of each local supervision entity 6 and the connectors 303 of the applications to use the network in competition. Upon the dispatching of a message by a local supervision entity 6, the message can thus be placed on standby in a queue until the network is available and/or until the message can actually be dispatched. From the point of view of the service or of the connector from which the dispatching of the message originates, the dispatching is considered to be done, but in actual fact the dispatching may be deferred.

Each supervision entity 6 furthermore comprises at least one sender 102 for transmitting the messages placed in the queues 101 to a dispatching client 103 corresponding to the appropriate network as a function of its recipient. If this client 103 cannot reach the identified recipient, the sender 102 can call upon the routing unit 15 so that it determines whether one or more other devices 5 can serve as relays. The message is then dispatched through these relay devices for transmission to the recipient.

Each supervision entity furthermore comprises a reception server 105 for the receipt of the messages originating from other supervision entities 6. The message received is placed in a mailbox 106 before being delivered to the service of the supervision entity for which it is intended. A mutex 107 can be used to prevent two requests received from being in competition. If the receiver device 5 does not correspond to the recipient of the message, the message is immediately returned so as to ensure the relay function allowing the gateways between different network types.

Each supervision entity 6 operating on an electronic device 5 which has a public address can launch an additional proxy server. On a device 5 configured to access a network by satellite, the address of one of these proxies can be specified beforehand to the supervision entity of the device via an interface. The device 5 will then be able to establish a connection with this proxy that it will keep open so as to be able to receive messages and data. The device 5 can also launch a client connected to this proxy which then will be chosen by its messages sender 102 for all the messages dispatched by its local supervision entity 6.

As a supplement, to avoid disconnections which may be caused by access providers, when establishing a connection with the proxy, the dispatching client 103 can dispatch, at regular intervals, a test message called “PING” (also designated by the acronym “Packet InterNet Groper”) intended to keep this connection open. This exchange of test messages also allows the device 5 and the proxy to detect losses of
the containers 805 of connectors 303;
a manager of component classes 226 for dynamically managing the loaded classes; it furthermore creates loaders of classes for each connection code file (related to mobility). Furthermore, listeners can be used (such as for example the broadcasting listener called “BroadcastReceiver” for devices of Android type) to allow the mobile devices 5 to toggle automatically from a mode of operation by proxy to the normal mode of operation without proxy, upon a change of type of connection.

The routing unit 15 allows the supervision system 10 to support any type of communication network between the mobile devices 5. In particular, it makes it possible to relay the messages when two devices 5 which depend on different communication networks cannot establish any direct communication between one another (for example, upon the creation of a connector distributed over two hosts having incompatible communication means). This makes it possible notably to establish at any moment a connection between two local supervision entities 6.

The routing unit 15 can be interrogated by the sender 102 of the supervision entity 6 to determine one or more relays on the route for a communication with the hosted supervision entity on another device, when necessary. It can also be interrogated by the supervision entity to determine the device which must receive a relay connector when two components must be connected although they do not have any possibility of a direct connection. Thus when the supervision entity on the host A receives a command to create a connector with the host B, the host A interrogates the routing unit 15 to find a route to B. This route may be direct or indirect, in the latter case the next relay host in the route able to serve as a relay is identified and a connector with relay is created for the relay host. The same processing is iterated for each next host relay on the route until the target device is reached.

In one embodiment of the invention, the search for routes uses a mechanism of “PING” type and broadcast messages (“broadcast”, “multicast”), or point-to-point messages to the neighbouring hosts. Thus if a device A searches for a route to reach a device B, the mechanism is as follows: the device A attempts firstly to reach the device B directly by dispatching a PING type message. If the device B responds to the PING message, the link is direct and the route search is terminated. In the converse case, the device A dispatches to all its neighbours (the message is dispatched by broadcasting, the receiver devices constituting the neighbour devices) a search message in respect of the device B. Each of its neighbours then attempts to reach the device B through a PING message. The devices which succeed in reaching the device B indicate to the device A that they can serve as relay for the device B. Those which do not succeed therein broadcast this request in their turn to their own neighbours. The device A may receive several responses. In this case, it can choose as route that which corresponds to the first response received and which represents the fastest route.

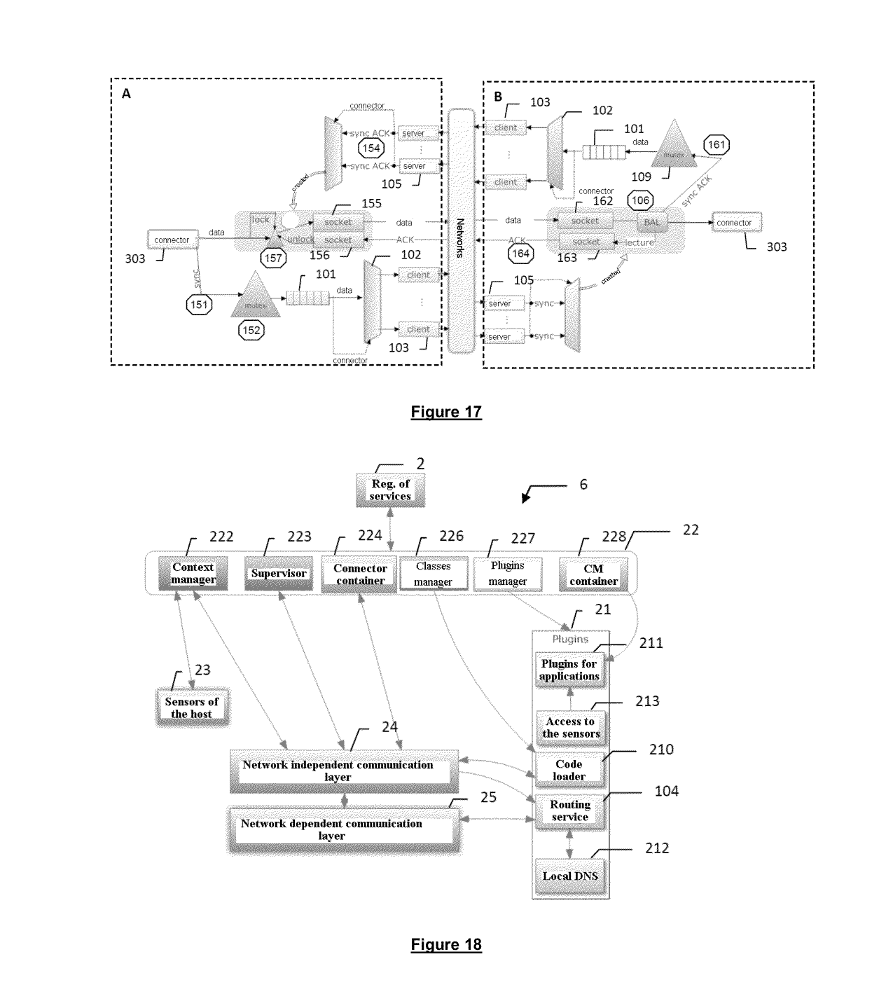

FIG. 17 illustrates the synchronization process implemented to synchronize the various parts 303A and 303B of a distributed connector 303 on a host A and a host B.

When a connector 303A is created on the host A, the local supervision entity 6 on the host A dispatches a “SYNC” synchronization message 151 which is transmitted on the network to the supervision entity 6 on the host B on which the other end of the connector 303B is situated. A mutual exclusion semaphore designated by the reference 152 can be used to manage the competing access of the synchronization messages 101 to the queue used by the dispatching clients 103 of the supervision entity 6 at the level of the host A.

In response to the creation of the other end of the connector 303B on the host B, the supervision entity 6 on the host B responds to the synchronization message through an “SYNC ACK” acknowledgement message designated by the reference 154 which is transmitted to the host A.

Moreover, in response to the receipt of the synchronization message, the local supervision entity 6 on the host B can also create a reception software interface (or reception “socket”) 162 to receive the data, a mailbox 106, and an acknowledgement software interface (or acknowledgement “socket”) 163 for the acknowledgements 164. Thus, when the connector 303B is created on the host B, it may find in the mailbox 106 the synchronization message dispatched by the other end of this connector 303B and respond thereto through an “SYNC ACK” acknowledgement message 161. Henceforth, the data received are placed in the mailbox 106 which contains only a single element. If the connector 303 recovers the data item in the mailbox 106, the mailbox 106 dispatches an acknowledgement message.

The receipt of the “SYNC ACK” acknowledgement message by the supervision entity on the host A can furthermore cause the creation of a software interface (or “socket”) for data dispatch 155 and of a software interface (or “socket”) 156 for receipt of acknowledgement on the host A. A semaphore 157 is put in place to prevent the possibility of a new data item being sent before the acknowledgement for the previous data item has been received. When a data item is dispatched by a connector 303, the synchronization semaphore is closed until an acknowledgement is received. This mechanism ensures the synchronous operation of the connectors 303 by implementing a control making it possible to ensure that the connectors do not dispatch more data than is recovered by the other end.

The mechanism for synchronizing the parts of connectors is applied in the same manner, on the one hand between one end of a relay connector placed on a host A and the central part of the relay connector placed on a host B, and on the other hand between the central part of the relay connector placed on the host and the other end of the relay connector placed on a host C.

The synchronization mechanism according to the embodiments of the invention allows notably a synchronous communication in each connector 303. Thus, each data item dispatched by the supervision entity hosting a part of a distributed or relay connector causes an acknowledgement of the receiving supervision entity hosting another part of the distributed or relay connector. A new data item can only be dispatched via the connector if the acknowledgement for the previous data item has been received from the receiving supervision entity hosting the other part of the distributed or relay connector. A connector thus corresponds to two physical links: a link for the data which flow in one direction and another link for the acknowledgements which flow in the opposite direction.

Such a synchronization process allows the supervision entities to verify that data transmitted are actually received, and to detect possible malfunctions of the network based connections in particular in a situation of mobility of the devices.

The supervision system 10 according to the embodiments of the invention thus makes it possible to control the communication between component and notably to create, delete, connect or disconnect components 302, in a transparent manner, while the application is operating.

FIG. 18 shows an exemplary kernel architecture for each local supervision entity 6 for the control of inter-component communication. Each local supervision entity 6 can comprise:
A registry of services 2 which allows the local supervision entity 6 to access a set of services offered by the supervision system 10;
A network independent communication layer 24 and a network dependent communication layer 25: these layers allow the local supervision entities 6 hosted on respective mobile devices to communicate with one another and serve as support to the connectors between components; the network independent communication layer 24 provides mechanisms (queues, semaphores, etc.) which can be used by the supervision entity and the connectors to dispatch and receive objects and the network dependent communication layer 25 provides notably mechanisms for implementing the network communications for the supervision entity and for the connectors.

The local supervision entity 6 can furthermore comprise the following elements 22 used for the supervision of the applications:
A supervision module 223 (also called a “supervisor”) to execute the commands for deployment or reconfiguration by controlling execution of commands for component creation, deletion, migration, connection, deconnection and/or execution of commands for connector creation, deletion, duplication, redirection;
A context manager 222 to control the context of the applications, notably on the basis of sensors of the device 23; it receives notably information on the state of the application currently executing, in particular information relating to the components, to the connectors linking the components and to the host devices 5;
The containers 805 of connectors 303;
A component classes manager 226 for dynamically managing the loaded classes; it furthermore creates class loaders for each code file downloaded for a new component received on the host;
The containers 305 of components 302; and
A modules manager 227 which may be extension modules (or plugins) for controlling a modules set 21. The modules manager 227 is adapted for launching or stopping modules 21 of the supervision entity. It can use a description file which indicates the plugins which are automatically executed when the supervision entity stops. Modules 21 can be added or deleted during execution.

The modules 21 can comprise a code loading function 210 for dynamically loading the code of the classes corresponding to the components 302 and to the objects exchanged between components.

The modules 21 can furthermore comprise:
A module for applications (also called “plugins for application”) 21 which allows the components to access resources managed by the supervision entity 6. These resources can comprise conventional resources (for example, texts, images, etc.) or else hardware specific resources (such as sensors 211, a GPS system (the acronym standing for “Global Positioning System”), or else an SMS system (the acronym standing for “Short Messaging System”, etc.)); this unit allows notably the components to dispatch commands to the local or remote supervision entities and to receive responses;
The routing unit 15 for the calculation of routes (also called routing service); and
The local DNS 212 (DNS is the acronym standing for “Domain Name System”).
   The registry of services 2 can operate in a manner similar to the JAVA application called “RMI registry” but in local mode, that is to say referring solely to the services hosted on the supervision entity 6 local to the electronic device 5. The services of the local supervision entity 6 are registered therein. For example, during the creation of a distributed connector, commands are dispatched to the other local supervision entities 6 while interrogating the registry of services 2 so as to obtain the service responsible for the network based communication layers 24 and 25. In the same manner, each connector 303 container 805 can be registered as a service which will be able to be used by the local supervision entity 6 to control it and allow its dynamic discovery by the component 302 containers 305 to establish their connection to the input or output streams. Moreover, each container 305 of a component 302 can register its control unit 40 as a service allowing the local supervision entity to control the various phases of the life cycle of a component.

The components 302 can access the services of the supervision system 302 by way of the registry of services 2, such as the services 211. The other services are accessible by the local supervision entity 6.

The supervision module 223 receives and executes commands originating from the other local supervision entities 6 hosted on the other mobile devices 5, from the components 302 or from a decision module.

These commands can include commands relating to the components 302 that may comprise commands to create, delete, migrate, connect, disconnect and duplicate the output streams of the components. These commands can comprise:
A component create command taking as parameters an input and outputs list that may be empty or marked to be used subsequently;
A command to delete a given component;
A command to dispatch a component to a destination;
A command to disconnect an input of a component;
A command to disconnect an output of a component;
A command to reconnect an input of a component; and
A command to duplicate an output of a component.

The commands can furthermore include commands relating to connectors 303, such as commands to create a connector, to delete connectors and to redirect connectors. The commands can also comprise commands relating to context making it possible to recover the states of the host 5, of the containers 224 of connectors 303, of the containers 305 of components, and of the quality of service indicated by a component. Such commands relating to context include:
a command which returns an object containing the context of a host, that is to say the memory occupancy, the state of the battery, the CPU load, the mean network bitrate at input and at output over the last second.
a command which returns an object containing the context of a container. If the name designates a component container 303, this command returns the names of the connected connectors at input and at output. If the name designates a container of connector 303, this command returns the addresses of the hosts hosting the input and the output of this connector.
a command which returns an object containing the Quality of Service of a container. If the name designates a component container 302, this command returns the value indicated by the component. If the name designates a container of connector 303, this command returns the degree of fill of the inputs and output buffers of the connector 303 as well as the mean bitrate since creation.

The local supervision entities 6 can execute a set of methods which must be overloaded, for example:
A method which returns the quality of service (QoS) offered by the component 302,
The method called “run_BC( )” which is executed to toggle a component 302 to the active state 52 (FIG. 5). In certain embodiments of the invention, the “Run_BC” method never terminates (data stream) and accordingly comprises a loop of the “while” type (while(isRunning( ) in programming language). If a component 302 wishes to stop its execution, in such a way that the local entity 6 can migrate it or stop it, a method called “idle( )” can be called.
   The local supervision entities 6 can furthermore execute methods that may be overloaded, notably:
The initialization method called “init( )”, for initializing a component 302. The initializations of the properties of a component 302 can be done in the “init” method or at the start of the “run_BC” method (before the loop). The “init” initialization method is executed during the first launch of the business component 302. However, it is not rebooted after a migration. The initializations done in the “init” method consequently relate to the properties which will be serialized during a migration. Thus, the creation of an interface, the access to local devices or the putting in place of events listeners on certain input streams can be done at the start of the “run_BC” method so as to be taken into account during a migration.
The destruction method called “destroy( )” which is executed upon the definitive stopping of the component and also before a migration.
   The following methods are inherited from the class of the models of components, called “BCModel”, and may be usable by each component 302. They comprise methods relating to the state of the component 302 including:
a component stopping method called “idle( )” which stops the component but does not delete it;
a method which indicates whether the component 302 can continue to execute, called “isRunning( )” and of boolean type. In the case where the component must be stopped, this method can lift the class exception called “StopBCException”.
a method indicating the state of migration of the component 302, of boolean type. This method can for example return the value “TRUE” if the component 302 has been migrated.
   The “idle( )” and “isRunning( )” methods are preferably disabling: if they are called by another execution thread, they do not execute and display an error.

The methods inherited from the “BCModel” components models class and usable by each component 302 can also comprise methods relating to the environment of the component such as:
A method which returns the name of the component;
A method which returns the number of inputs of the component 302;
A method which returns the number of currently connected inputs of the Component 302;
An input connection indication method to indicate whether the input designated by the parameter is currently connected to a connector;
A method which returns the number of outputs of the component 302;
A method which returns the number of currently connected outputs of the component 302;
An output connection indication method to indicate whether the output designated by the parameter is currently connected to at least one connector.

The methods inherited from the “BCModel” components models class and usable by each component 302 can also comprise Methods relating to the inputs such as:
A method for creating a filter of data of a specified class, on an input of the component 302;
A method for deleting the filter of data on an input of the component 302 which receives an input number as parameter;
A method for reading the data on an input of the component;
A method for reading the data of a class on an input of the component;
A method for reading the first data item available on one of the inputs of the component 302;
A method which indicates the availability of data on an input of the component 302;
A method for adding a listener as input of a component 302;
A method for deleting listeners.

Other methods usable by the components can relate to the outputs of the components 302 and comprise a method for writing on an output of the component 302.

Other methods that can be called by the components may relate to events (input listeners or interfaces), such as a standby method for awaiting a component event or a method for dispatching an event to the component.

The components 302 can also call methods relating to the resources contained in the code file associated with the component (jar file). The resources can be placed in a sub-directory of the directory containing the component. The component 302 can access it by using methods called “getResourceAsByteArray” (recovery of the resource in binary form) or “getResourceAsStream” (recovery of a reading stream for the resource).

According to another characteristic of the invention, each local supervision entity 6 can maintain information relating to all the local supervision entities 6 with which it has entered into communication. In particular, this information can be registered in the local DNS 212. For each other local supervision entity 6 identified by the DNS 212, the DNS 212 can store the following information:
A unique identifier associated with the local supervision entity 6;
The list of the known addresses of this local supervision entity 6 on each of the networks which it accesses;
The clock Shift with this local supervision entity 6 and the maximum error of measurement of this shift.

During each message receipt (for example, class search message) by the local supervision local entity 6 originating from a local supervision entity 6 hosted on another device, the DNS 212 registers the sending supervision entity 6 and its address. During exchanges of messages of PING or route search type, on receipt of the response, the DNS 212 calculates the shift of clocks (these messages contain the send time extracted from the local clock of the sending supervision entity 6). The time of exchange of these messages furthermore makes it possible to determine a maximum error bound on the measurement of this shift.

Each indirect route found causes the addition of the supervision entity 6 serving as relay and of that at which the route culminates.

Moreover, at regular intervals, the supervision entities 6 can exchange the contents of their DNSs 212. The information thus received can be used to update each local DNS, notably to add supervision entities 6 which were not registered therein, or to supplement the lists of addresses of the supervision entities 6.

The clock shifts received make it possible to calculate new values, for example:
Shift between host A and host B=shift between A and C+shift between C and B, and
Error in the shift between host A and host B=Error in the shift between A and C+Error in the shift between C and B.

These values can thus supplement the local DNS 212 or replace the local values when the calculated error is less than that customarily known locally.

The clock shifts of the DNS can be used for the management of the connections, notably to date the objects exchanged in local time. Indeed, the dispatched data are automatically dated upon their creation and this date is adjusted by the connectors 303 upon receipt. When the clock shift with the sender host is not known, the connector 303 dates the data item by the local time of its receipt.

To take account of the mobility of the devices 5, the registrations of the DNS 212 preferably have a limited lifetime and are deleted at their term. A maximum value can be assigned to this lifetime during each successful communication, and then readjusted on the basis of the lifetimes of the DNSs received from the other supervision entities 6 (the maximum value can then be retained). Thus a supervision entity 6 which disappears or loses all connection will be able to be deleted from all the DNSs. Likewise, a supervision entity 6 which does not communicate with any other supervision entity (for example, no message has been exchanged with other supervision entities) will be able to be deleted from all the DNSs, and reappear in the DNSs as soon as the corresponding supervision entity communicates again with other supervision entities.

As a supplement, the components 805 encapsulated in the containers 303 can offer a method indicating the quality of service that they offer. This method can be called at any instant by the platform to evaluate the Quality of service of the application.

The connectors can control the state of their internal buffers (in terms of number of objects on standby) and measure their instantaneous and mean bitrate (in Kbytes/s). They can preserve this information so as to be able to transmit it on request and raise alarms when these values cross certain (parametrizable) thresholds. In order to be able to detect dips and hikes in the quality of service, these alarms can correspond either to high thresholds or to low thresholds.

Moreover, each supervision entity can comprise an alarms management unit for receiving alarms originating from the capture of the context. This unit can also receive information on the current state of the application, the connections and the device. On the basis of these alarms and the information collected, the alarms management unit can trigger reconfigurations with the aim of maintaining the best possible quality of service as a function of the current context. Thus, for example, when a component affords a low Quality of service, the supervision entity can attempt to find a configuration in which it will be replaced with a component that can afford a better quality of service. The supervision entity may also attempt to move one or more components from this host to another. Such a decision may for example be triggered when connectors signal an accumulation of data (caused for example by saturation of the network) or when the host signals weak resources (CPU/RAM/Energy).

The inventors have performed a certain number of measurements relating to the supervision system 10, in particular on the complexity, the time to execute the commands, the times to transfer information in the connectors and the time to deploy an application.

Most of the executions of commands supported by the supervision system induce short standby times (response by network of another supervision entity, route search etc.). A reconfiguration generally consists of several commands (addition/deletion of components and/or of connectors for example). These standby times are optimized by the supervision system 10 by allowing the parallel execution of these commands. Hence, the time to execute a reconfiguration is less than the sum of the times to execute each of the commands taken independently.

In accordance with the measurements performed, the reconfiguration times are sufficiently short to allow the supervision system to rapidly adapt an application to a change of context. The scaling (bigger number of devices involved in the reconfiguration) does not modify the situation significantly since each supervision entity on a device can execute its commands in parallel with the others.

The supervision system 10 according to the invention thus makes it possible to execute applications (i.e. components forming all or part of an application) on various devices 5, possibly mobile, and to act warm on the architecture of the application when necessary. It furthermore makes it possible to control the communication between application components, independently of the components themselves which operate in an autonomous manner.

The invention is not limited to the embodiments described hereinabove by way of nonlimiting example. It encompasses all the variant embodiments that may be envisaged by the person skilled in the art. In particular, the invention is not limited to the supervision entities architecture represented in FIG. 18. Neither is it limited to the particular arrangement of communication elements of FIGS. 16 and 17. Moreover, the supervision entities can be parametrized in various ways, by the user. Thus, the supervision entities can use a list of components refused, which can be parametrized through a configuration interface for the supervision entity, so as to designate components which must not be installed on the device (for example a component that has to use a GPS location system will not be installed by the supervision entity if the user has specified that he refused to be located). The supervision entities can furthermore be configured to manage the purchase of components.

The person skilled in the art will moreover understand that the supervision entities 6 according to the embodiments of the invention can be implemented in diverse ways by hardware, software, or a combination of hardware and software.

In particular, the elements of each supervision entity can be combined or separated into sub-elements to implement the invention. Furthermore, they can be implemented in the form of computer programs executed by a processor. A computer program is a set of instructions which can be used, directly or indirectly, by a computer.

A computer program can be written in any programming language, including the compiled or interpreted languages, and it can be deployed in any form whatsoever in the chosen computing environment.

1. A system for supervising applications executing on a set of electronic devices connected together by one or more networks, wherein each device comprises a local supervision entity, the supervision entities cooperating together to control the applications executing on the electronic devices, each application comprising a set of application components, each application component being encapsulated in a container and the components being connected together by connectors, each component container comprising at least one input unit for receiving the input streams, at least one output unit for receiving the output streams, and a control unit, the supervision entity of the device hosting a component being able to control the life cycle of the component between the devices by using said control unit, while the component is able to access its input and output data by using the input and output units of said container.

2. The supervision system according to claim 1, wherein the component is able to access its input data, by direct reading on a chosen stream, by an operation of disabling until a data item is available.

3. The supervision system according to claim 1, wherein the component is able to access its input data, by direct reading of the first data item available on one of the input streams, by a disabling operation.

4. The supervision system according to claim 1, wherein the component container comprises a set of listeners placed on at least some of these input streams, and in that each listener is able to call a method for reading data, in response to the presence of a data item on the input stream where the listener is placed.

5. The supervision system according to claim 4, wherein the container furthermore comprises a listeners manager cooperating with the control unit of the component container so as to activate listeners on input streams of the component, in response to an item of information, transmitted to the control unit by an input connector, regarding availability of data on the input connector.

6. The supervision system according to claim 5, wherein, in response to a command to stop the component, transmitted by the supervision entity of the device hosting the component to the control unit of the container of the component, the control unit stops the listening manager.

7. The supervision system according to claim 1, wherein the component is able to write directly on an output stream, the operation being disabling if no output stream is connected to the corresponding output.

8. The supervision system according to claim 1, wherein, in response to a command to start the component, transmitted by the supervision entity of the device hosting the component to the control unit of the container of the component, if the component is not connected to a connector, the control unit boots the component and continues its execution as long as the component does not attempt to access an input stream or an output stream.

9. The supervision system according to claim 1, wherein, in response to a command to stop an input unit of the component, transmitted by the supervision entity of the device hosting the component to the control unit of the container of the component, the control unit is able to stop the component if the component attempts to read a data item on the stopped input unit.

10. The supervision system according to claim 1, wherein, in response to a command to stop a component or to migrate a component to another device, transmitted by the supervision entity of the device hosting the component to the control unit of the container of the component, the control unit is able to stop all the input units of the component.

11. The supervision system according to claim 1, wherein each input unit of the active component is able, on each attempted reading of the component on the input unit, to attempt to recover data if it is connected to a connector or to disable the readings of the component on the input unit until it is connected to a connector.

12. The supervision system according to claim 1, wherein each connector is encapsulated in a container of connector, an input unit, an output unit and a control unit cooperating with the supervision entity.

13. The supervision system according to claim 1, wherein the supervision entity of a given device is able, in response to the receipt of a command to create a connector between the given device, so-called the source device, and a target device, the source device and the target device having compatible communication means, to:
send a command to create a container of connector on the target device and locally create a container of connector on the source device,
synchronize the creation of the connectors on the source device and the target device, according to a mechanism of acknowledgement message exchange between the devices.

14. The supervision system according to claim 1, wherein the supervision entity of a given device is able, in response to the receipt of a command to create a connector between the given device, so-called the source device, and a target device, the source device and the target device having incompatible communication means, to:
calculate a route between the source device and the target device,
for each next relay device in the route between the source device and the target device having communication means compatible with the source device and the target device, until the target device is reached:
sending a command to create a connector container on said next relay device,
locally creating a container of connector on the current device which has sent the command, the supervision entity of said current device being configured to create a container of relay connector and
sending a command to create a connector container to the next relay device;
wherein the creation of the connectors on the current device and on the next relay device is synchronized according to a mechanism of acknowledgement message exchange between the devices.

15. The supervision system according to claim 12, wherein the mechanism of synchronization between the supervision entity of a next device and of a current device in the route between the source device and the target device comprises:
the dispatching of a synchronization message to the supervision entity of the current device
in response to the creation of the other end of the connector on the next device, the dispatching of a message of acknowledgement by the supervision entity of the next device to the supervision entity of the current device.

16. The supervision system according to claim 15, wherein, in response to the creation of the other end of the connector on the next device, the supervision entity of the next device further creates a software interface for receiving the data, and a software interface for the acknowledgements.

17. The supervision system according to claim 15, wherein, in response to the receipt of the message of acknowledgement by the supervision entity of the current device, the supervision entity of the current device creates a software interface for dispatching data and an acknowledgement reception software interface.

18. The supervision system according to claim 17, wherein the supervision entity of the next device further creates a mailbox for storing the synchronization messages arriving from other supervision entities.

19. The supervision system according to claim 1, wherein the supervision entities encapsulate the data exchanged between the components in an encapsulation class.

20. The supervision system according to claim 19, wherein, if a device hosting a connector which receives encapsulated data does not locally have the class of the objects, the connector manipulates only the data of the encapsulation class.

21. The supervision system according to claim 19, wherein, if a device hosting a connector which receives encapsulated data does locally have the class of the objects, the container of connector is able to extract the encapsulation class of the contained object.

22. The supervision system according to claim 1, wherein the objects exchanged between components are serialized.
